(19) United States
(12) Patent Application Publication
(10) Pub. No.: US 2015/0007805 A1
(43) Pub. Date: Jan. 8, 2015

(54) Powered tile breaker

(71) Applicant: Richard Tailly, Yamaska (CA)

(72) Inventor: Richard Tailly, Yamaska (CA)

(21) Appl. No.: 13/935,488

(22) Filed: Jul. 4, 2013

(51) Int. Cl. B28D 1/26; B28D 1/32; B25D 11/00

(52) U.S. Cl. CPC B28D 1/26; B25D 11/00; B28D 1/322
USPC 125/23.01

(57) ABSTRACT

A powered tile breaker having a main adjustable frame with handlebars located at a top end section thereof, at least one wheel located at a lower end section thereof, and an adjustable shaft connected between the top end section and the lower end section. A main motor located inside a main motor frame pivotally connected to the lower end section; a chiseling device mechanically connected to the main motor and adapted to deliver repeating chiseling strokes to a chosen tile; and an adjustment mechanism connected between the lower end section of the main adjustable frame and the motor frame, the adjustment mechanism capable of changing and securely holding the motor frame, main motor and the chiseling device at a chosen angle with respect to the lower end section to thereby provide repeating chiseling strokes to a chosen tile at a chosen angle.

This application claims priority based on request GB1212001.0 filed Jul. 5, 2012

### FIELD OF THE INVENTION

The present invention relates generally to powered tools but more particularly to a powered tile breaker.

### BACKGROUND OF THE INVENTION

Breaking ceramic tiles is a very hard job and special chisels have been developed for that task. Still doing that manually is hard and takes a long time. There needs to be a better way of removing ceramic tiles.

### SUMMARY OF THE INVENTION

In view of the foregoing disadvantages inherent in the known devices now present in the prior art, the present invention, which will be described subsequently in greater detail, is to provide objects and advantages which are:

To provide for a powered chiseling tool that is movable on wheel and that has a set of handles positioned so that a user can operate the device while keeping an upright posture.

In order to do so, the invention consists a powered tile breaker having a main adjustable frame with handlebars located at a top end section thereof, at least one wheel located at a lower end section thereof, and an adjustable shaft connected between the top end section and the lower end section. A main motor located inside a main motor frame pivotally connected to the lower end section; a chiseling device mechanically connected to the main motor and adapted to deliver repeating chiseling strokes to a chosen tile; and an adjustment mechanism connected between the lower end section of the main adjustable frame and the motor frame, the adjustment mechanism capable of changing and securely holding the motor frame, main motor and the chiseling device at a chosen angle with respect to the lower end section to thereby provide repeating chiseling strokes to a chosen tile at a chosen angle.

The main motor includes a main motor frame securely connected between a middle portion of the adjustable frame and the lower end section of the main adjustable frame, wherein the main motor frame includes a pivot bar member securely attached to the main motor frame and the chiseling device, such that the motor frame and the chiseling device can be pivoted around the pivot bar member.

The adjustment mechanism is connected between the lower end section of the main adjustable frame and the pivot bar member of the motor frame, and includes a worm screw and an electric motor for turning the worm screw in opposite radial directions, to thereby adjust the pivot angle of the pivot bar member.

The powered tile breaker has an angle control button located on the top end section and used to adjust and control the angle of the motor frame and the chiseling device.

The angle control button is electrically connected to the electric motor of the adjustment mechanism.

The chiseling device includes a tile pusher connected to the main motor and adapted to move broken tiles aside, and a chisel member mechanically connected to the main motor such that the main motor pushes and pulls the chisel member in a liner direction thereby creating the repeating chiseling strokes.

The motor frame includes a set of indicia on a side portion thereof and used to indicate the angle to which the motor frame, main motor, and the chiseling device are positioned with respect to the lower end section.

The middle portion of the adjustable frame is formed as a shaft comprising two abutting frame members connected by a hinge member and a lock member, such that the adjustable frame can be unlocked and folded into a storage configuration, or locked in a linear configuration and ready for use.

The main motor is an electric motor.

There are two wheels located on opposite sides of the lower end section.

The powered tile breaker has a power button connected to the handlebars and used to turn on and off the main motor.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of the invention.

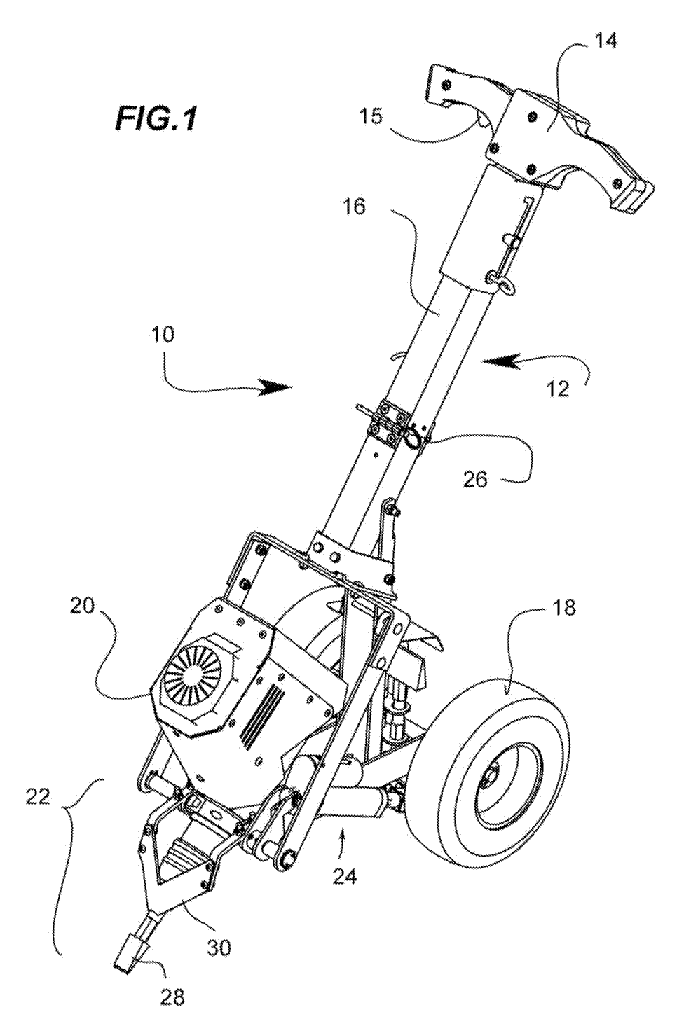

FIGS. 2a-b Front and side views, respectively.

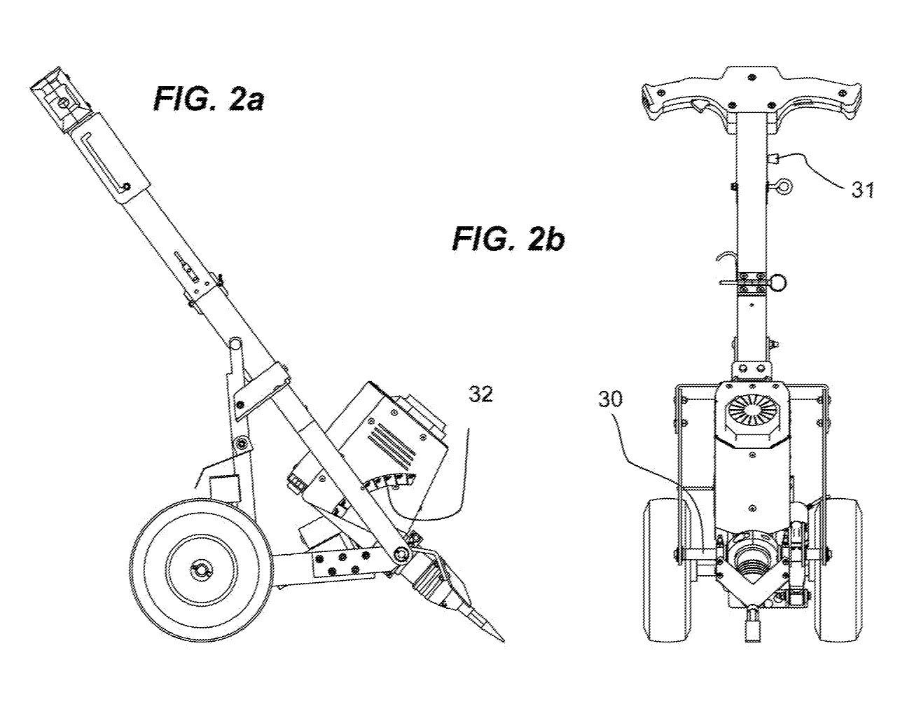

FIG. 3 View from the opposite side of FIG. 2a.

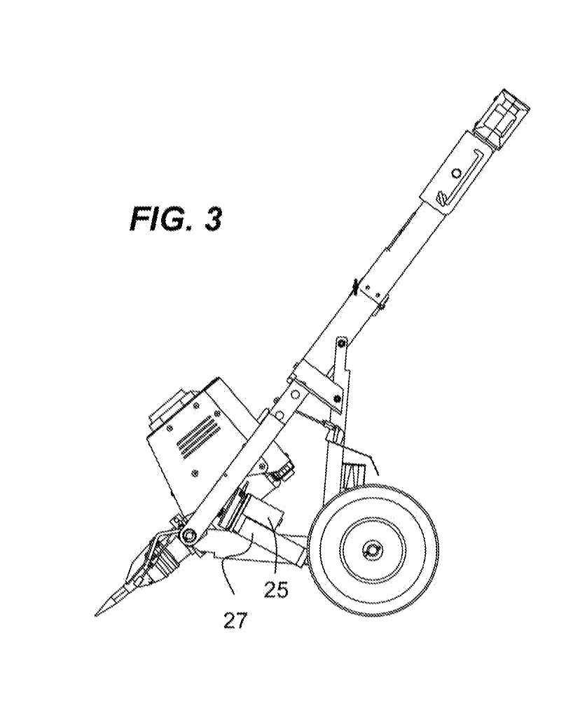

### DETAILED DESCRIPTION OF THE PREFERRED EMBODIMENT

A powered tile breaker (10) has an adjustable frame (12) having a set of handlebars (14), a shaft (16), and wheels (18) to hold a main electric motor (20) which powers a chiseling device (22) located at ground level.

The main electric motor (not shown) is located inside a motor frame (20), the latter being angularly adjustable by way of an adjustment means (24) which consists in an electric motor (25) driving a worm screw (27). The adjustment means (24) is controlled by a simple “up and down” button (31) located on the handlebars (14). A set of indicia (32) located on the side of the motor frame (20) is used as a reference to indicate the angle of rotation of the the motor frame (20) as it pivots around a pivot bar member (30).

The shaft (16) has a hinge and lock means (26) so that it can be folded in half.

The chiseling device (22) has a chisel (28) with repeating chiseling strokes, and a tile pusher (30) to move broken tiles aside. The repeating chiseling strokes is what cracks and breaks the tiles.

There is, of course, a main on/off switch (15) on the handlebars to turn the tile breaker (10) on or off.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A powered tile breaker comprising a main adjustable frame having handlebars located at a top end section thereof, at least one wheel located at a lower end section thereof, and an adjustable shaft connected between said top end section and said lower end section; a main motor located inside a motor frame; said motor frame pivotally connected to said lower end section; a chiseling device mechanically connected to said main motor and adapted to deliver repeating chiseling strokes to a chosen tile; and an adjustment mechanism connected between said lower end section of said main adjustable frame and said motor frame, said adjustment mechanism capable of changing and securely holding said motor frame, said main motor, and said chiseling device at a chosen angle with respect to said lower end section to thereby provide repeating chiseling strokes to a chosen tile at a chosen angle.

2. The powered tile breaker of claim 1, wherein said main motor includes a main motor frame securely connected between a middle portion of said adjustable frame and said lower end section of said main adjustable frame, wherein said main motor frame includes a pivot bar member securely attached to said motor frame and said chiseling device, such that said main motor frame and said chiseling device can be pivoted around said pivot bar member.

3. The powered tile breaker of claim 2, wherein said adjustment mechanism is connected between said lower end section of said main adjustable frame and said pivot bar member of said motor frame, and includes a worm screw and an electric motor for turning said worm screw in opposite radial directions, to thereby adjust the pivot angle of said pivot bar member.

4. The powered tile breaker of claim 1, further comprising an angle control button located on said top end section and used to adjust and control said angle of said motor frame and said chiseling device.

5. The powered tile breaker of claim 4, wherein said angle control button is electrically connected to said electric motor of said adjustment mechanism.

6. The powered tile breaker of claim 1, wherein said chiseling device includes a tile pusher connected to said main motor and adapted to move broken tiles aside; and a chisel member mechanically connected to said main motor such that said main motor pushes and pulls said chisel member in a liner direction thereby creating said repeating chiseling strokes.

7. The powered tile breaker of claim 1, wherein said motor frame includes a set of indicia on a side portion thereof and used to indicate the angle to which said motor frame, main motor, and said chiseling device are positioned with respect to said lower end section.

8. The powered tile breaker of claim 2, wherein said middle portion of said adjustable frame is formed as a shaft comprising two abutting frame members connected by a hinge member and a lock member, such that said adjustable frame can be unlocked and folded into a storage configuration, or locked in a linear configuration and ready for use.

9. The powered tile breaker of claim 1, wherein said main motor is an electric motor.

10. The powered tile breaker of claim 1, wherein said at least one wheel comprises two wheels located on opposite sides of said lower end section.

11. The powered tile breaker of claim 1, further comprising a power button connected to said handlebars and used to turn on and off said main motor.
